(19) United States
(12) Patent Application Publication
(10) Pub. No.: US 2005/0076369 A1
(43) Pub. Date: Apr. 7, 2005

(54) Method and apparatus for assigning temporary mobile group identity in a multimedia broadcast/multicast service

(76) Inventors: Zhijun Cai, N. Richland Hills, TX (US); Bonnie Chen, DeSoto, TX (US)

Correspondence Address: MOTOROLA, INC., 1303 EAST ALGONQUIN ROAD, IL01/3RD, SCHAUMBURG, IL, 60196, US

(21) Appl. No.: 10/945,481

(22) Filed: Sep. 20, 2004

Related U.S. Application Data
(60) Provisional application No. 60/509,009, filed on Oct. 6, 2003.

(51) Int. Cl. H04N 7/16; H04M 11/00; H04Q 7/20

(52) U.S. Cl. 725/62; 455/403; 455/454

(57) ABSTRACT

A Multimedia Broadcast/Multicast Service (MBMS) server in a packet data communication system generates and assigns Temporary Mobile Group Identities (TMGIs) to MBMS services, thereby serving as a central repository for the TMGIs. In response to receiving a request to participate in an MBMS service, the MBMS server generates a TMGI. The MBMS server assigns the TMGI to the MBMS service and stores the TMGI in association with information relating to the MBMS service to produce a stored TMGI. The MBMS server further conveys the TMGI to a source of the received request, thereby providing for a distribution of the TMGI to mobile stations subscribed to the MBMS service. The subscribed mobile stations may then use the TMGI to receive data packets associated with the MBMS service.

### CROSS-REFERENCE TO RELATED APPLICATION

This application is related to U.S. patent application Ser. No. 60/492,876, attorney docket no. CE11779N, filed Aug. 6, 2003, and claims priority from provisional application Ser. No. 60/509,009, entitled “METHOD AND APPARATUS FOR ASSIGNING A TEMPORARY MOBILE GROUP IDENTITY IN A MULTIMEDIA BROADCAST/MULTICAST SERVICE,” filed Oct. 6, 2003, which is commonly owned and incorporated herein by reference in its entirety.

### FIELD OF THE INVENTION

The present invention relates generally to packet data communication systems, and, in particular, to a multimedia broadcast multicast service in a packet data communication system.

### BACKGROUND OF THE INVENTION

The Universal Mobile Telecommunication Service (UMTS) standard provides a compatibility standard for cellular mobile telecommunications systems. The UMTS standard ensures that a mobile station (MS), or user equipment (UE), operating in a UMTS system can obtain communication services when operating in a system manufactured according to the standard. To ensure compatibility, radio system parameters and data transfer procedures are specified by the standard, including protocols governing digital control messages and bearer traffic that are exchanged over an air interface.

The UMTS standards provide, in 3GPP TS 25.344 (Third Generation Partnership Project Technical Specification 25.344) v0.5.0, 3GPP TS 23.246 v1.1.0, and 3GPP TS 23.846 v6.1.0, for a provision of a Multimedia Broadcast/Multicast Service (MBMS) service by a UMTS communication system to MSs serviced by the system and subscribed to the service. When a mobile station (MS) activates in a communication system that provides an MBMS service, such as a broadcast of audio, video, and/or data concerning a sporting event such as a Super Bowl or a World Cup soccer game, the MS may register for the MBMS service by indicating to the communication system a willingness to receive multicast data associated with the MBMS service. By registering for the MBMS service, the MS joins a multicast group associated with the MBMS service. In response to receiving a registration request from the MS, a Serving 3G-GPRS Support Node (SGSN) located in the system conveys to the MS, via a Radio Access Network (RAN) servicing the MS, a Temporary Mobile Group Identity (TMGI) that is associated with the MBMS service and the corresponding multicast group. The TMGI is then used by the communication system to notify the MS when the communication system has MBMS data to convey to the MS that is associated with the corresponding MBMS service/multicast group.

The UMTS standards, however, fail to specify an element of the communication system that creates the TMGI or a procedure for assigning a TMGI to an associated multicast group and a corresponding MBMS service. Therefore, a need exists for a method and apparatus that provides for creation and assignment of a TMGI associated with a MBMS service in a wireless communication system.

### BRIEF DESCRIPTION OF THE DRAWINGS

FIG. 1 is a block diagram of a wireless communication system in accordance with an embodiment of the present invention.

FIG. 2 is a block diagram of a mobile station of FIG. 1 in accordance with an embodiment of the present invention.

FIG. 3A is a logic flow diagram of a method by which the communication system of FIG. 1 generates, assigns, and distributes a Temporary Mobile Group Identity associated with a Multimedia Broadcast/Multicast Service in accordance with an embodiment of the present invention.

FIG. 3B is a continuation of the logic flow diagram of FIG. 3A of a method by which the communication system of FIG. 1 generates, assigns, and distributes a Temporary Mobile Group Identity associated with a Multimedia Broadcast/Multicast Service in accordance with an embodiment of the present invention.

FIG. 4 is a block diagram of a Temporary Mobile Group Identity in accordance with an embodiment of the present invention.

### DETAILED DESCRIPTION OF THE INVENTION

To address the need for a method and an apparatus that that provides for creation and assignment of a TMGI associated with a MBMS service in a wireless communication system, a Multimedia Broadcast/Multicast Service (MBMS) server is provided in a packet data communication system that generates and assigns Temporary Mobile Group Identities (TMGIs) to MBMS services, thereby serving as a central repository for the TMGIs. In response to receiving a request to participate in an MBMS service, the MBMS server generates a TMGI. The MBMS server assigns the TMGI to the MBMS service and stores the TMGI in association with information relating to the MBMS service to produce a stored TMGI. The MBMS server further conveys the TMGI to a source of the received request, thereby providing for a distribution of the TMGI to mobile stations subscribed to the MBMS service. The subscribed mobile stations may then use the TMGI to receive data packets associated with the MBMS service.

Generally, an embodiment of the present invention encompasses a method for assigning a Temporary Mobile Group Identity (TMGI) to a Multimedia Broadcast/Multicast Service (MBMS) communication session. The method includes receiving, by an MBMS server, a request to participate in an MBMS service, in response to receiving the request, generating, by the MBMS server, a TMGI, assigning, by the MBMS server, the TMGI to the MBMS service, storing, by the MBMS server, the TMGI in association with information relating to the MBMS service to produce a stored TMGI, and conveying, by the MBMS server, the TMGI to a source of the received request.

Another embodiment of the present invention encompasses an MBMS server that includes at least one memory device and a processor operably coupled to the at least one memory device. The processor receives a request to participate in an MBMS service, generates a TMGI in response to receiving the request, assigns the TMGI to the MBMS service, stores in the at least one memory device the TMGI in association with information relating to the MBMS service to produce a stored TMGI, and conveys the TMGI to a source of the received request.

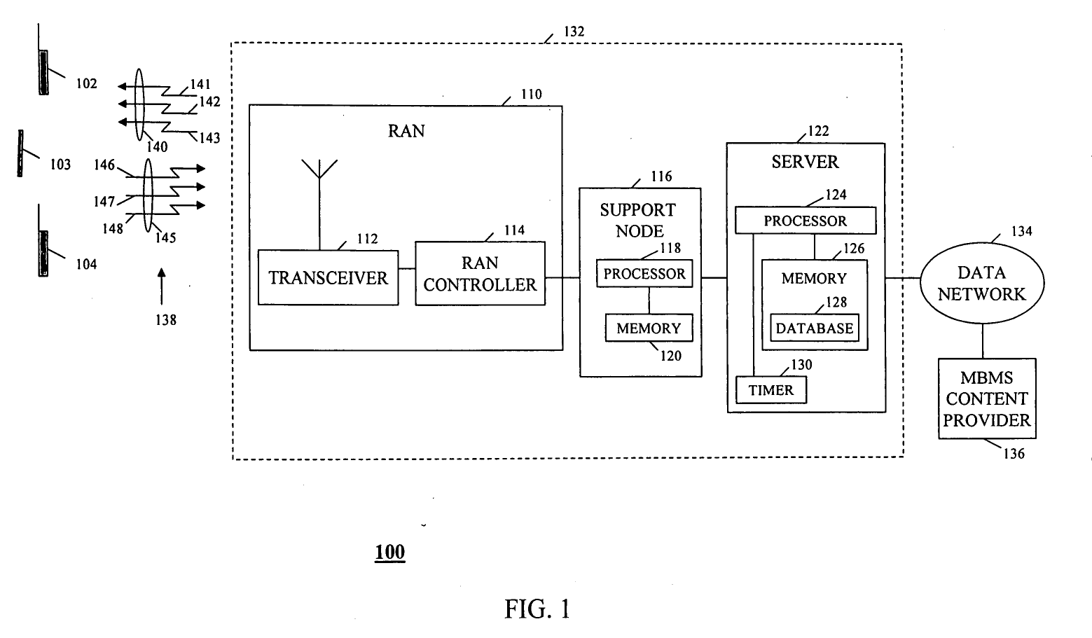

The present invention may be more fully described with reference to FIGS. 1-4. FIG. 1 is a block diagram of a wireless communication system 100 in accordance with an embodiment of the present invention. Communication system 100 includes multiple mobile stations (MSs), or user equipment (UE), 102-104 (three shown), such as but not limited to a cellular telephone, a radio telephone, a personal digital assistant (PDA) with radio frequency (RF) capabilities, or a wireless modem that provides RF access to digital terminal equipment (DTE) such as a laptop computer, in wireless communication with a Radio Access Network (RAN) 110. RAN 110 includes at least one transceiver, or Node B, 112 that is operably coupled to a RAN controller 114, preferably a Radio Network Controller (RNC). Communication system 100 further includes a support node 116 coupled to RAN 110 and a Multimedia Broadcast/Multicast Service (MBMS) server 122, preferably a Broadcast Multicast Service Center (BM-SC), in communication with RAN controller 114 via the support node. Support node 116 typically includes one or more Serving 3G-GPRS Support Nodes (SGSNs) that are each coupled to one or more Gateway 3G-GPRS Support Nodes (GGSNs). However, the precise architecture of support node 116 is up to an operator of communication system 100 and is not critical to the present invention. Together, RAN 110, support node 116, and server 122 are collectively referred to herein as an infrastructure 132.

Each of MSs 102-104 is capable of receiving and displaying audio, video, and/or data associated with an MBMS service provided by communication system 100, which service provides for a distribution of MBMS data to the MSs. MBMS services are described in detail in the 3GPP (Third Generation Partnership Project) standards, and in particular 3GPP TS (Technical Specification) 25.344 v0.5.0, 3GPP TS 23.846 v6.0.0, 3GPP TS 22.146 v6.0.0, 3GPP TS 23.246 v1.1.0, 3GPP TR (Technical Report) 21.905 v5.4.0, and Report R2-030063, which specifications and reports are hereby incorporated by reference herein and copies of which may be obtained from the 3GPP via the Internet or from the 3GPP Organization Partners' Publications Offices at Mobile Competence Centre 650, route des Lucioles, 06921 Sophia-Antipolis Cedex, France.

RAN 110 provides communications services to mobile stations, such as MS 102-104, located in a coverage area, such as a cell, serviced by the RAN via an air interface 138. Air interface 138 comprises a downlink 140 and an uplink 145 that each includes multiple communication channels. Preferably, downlink 140 includes a paging channel 141, at least one downlink control channel 142, and at least one downlink traffic channel 143. Preferably, uplink link 145 includes an uplink access channel 146, at least one uplink control channel 147, and at least one uplink traffic channel 148.

Communication system 100 further includes a Multimedia Broadcast/Multicast Service (MBMS) content provider 136, such as an IP multicast server, that is coupled to infrastructure 132, and in particular to server 122, via a data network 134, such as an IP network. As part of an MBMS service provided by communication system 100 and that may be subscribed to by each of MSs 102-104, MBMS content provider 136 sources MBMS data, typically in the form of IP data packets, to MSs 102-104 via server 122, support node 116, and RAN 110.

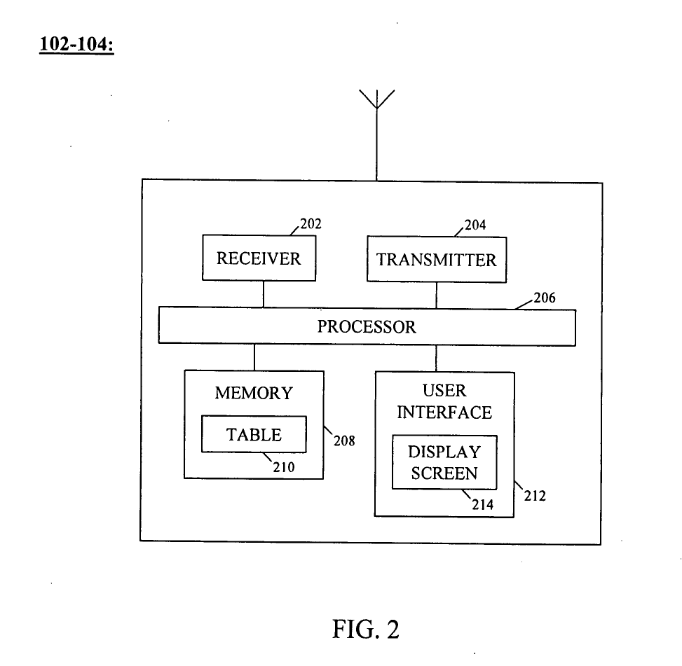

Referring now to FIGS. 1 and 2, each of support node 116, server 122, and MSs 102-104 includes a respective processor 118, 124, 206 such as one or more microprocessors, microcontrollers, digital signal processors (DSPs), combinations thereof or such other devices known to those having ordinary skill in the art. Each of support node 116, server 122, and MSs 102-104 further includes a respective one or more memory devices 120, 126, 208 associated with the respective processor, such as random access memory (RAM), dynamic random access memory (DRAM), and/or read only memory (ROM) or equivalents thereof, that store data and programs that may be executed by the processor and allow the processor to operate in communication system 100. The one or more memory devices 208 of each MS 102-104 further maintains a mobile identifier (mobile ID) associated with the MS and a Service Identifier (Service ID) associated with an MBMS service provided by communication system 100. The one or more memory devices 120 of support node 116 further maintains a support node identifier that is uniquely associated with the support node.

The Service ID is an identifier that is uniquely associated with the MBMS service. In one embodiment of the present invention, the Service ID may comprise, or be a function of, a routing address, such as an Internet Protocol (IP) multicast address, that identifies the MBMS service. For example, the routing address may be an IP address, for example, 10.10.10.10, associated with an MBMS data source, such as MBMS content provider 136, sourcing the data related to the event or an application on server 122 sourcing MBMS data. In another embodiment of the present invention, the Service ID may comprise or be a function of the routing address and may further comprise, or be a function of, an Access Point Name (APN) that is associated with a specific support node, such as support node 116, or an MBMS server, such as server 122. For example, the APN may be a Uniform Resource Locator (URL) associated with a service provider, such as the operator of communication system 100, operating the support node or server, for example, “t-mobile.com.” In other embodiments of the present invention, the Service ID may be any identifier that distinguishes an MBMS service provided by communication system 100 from all other MBMS services provided by the communication system, thereby allowing the communication system to separately identify each MBMS service.

Each of MSs 102-104 further includes a receiver 202, a transmitter 204, and user interface 212 that are operably coupled to processor 206. Receiver 202 and transmitter 204 respectively provide for receiving and transmitting messages by the MS. User interface 212 includes a display screen 214 and provides a user of the MS with the capability of interacting with the MS, including inputting instructions into the MS. In one embodiment of the present invention, user interface 212 may further include a keypad that includes multiple keys via which a user of the MS may input an instruction to the MS. In another embodiment of the present invention, display screen 214 may comprises a touch screen that is able to determine a position (i.e., an X-coordinate and a Y-coordinate) of a user's touch on the touch screen and convey the position data to processor 206. Based on the position data, processor 206 then translates the user's touch into an instruction. Preferably, the touch screen may display a “keypad” screen that comprises multiple softkeys such softkeys corresponding to keys on a conventional telephone keypad.

Preferably, communication system 100 is a Universal Mobile Telecommunication Service (UMTS) communication system that operates in accordance with the 3GPP (Third Generation Partnership Project) standards, which provide a compatibility standard for UMTS air interfaces and which standards are hereby incorporated herein in their entirety. The standards specify wireless telecommunications system operating protocols, including radio system parameters and call processing procedures. In communication system 100, the communication channels of downlink link 134 or uplink link 135, such as access channels, control channels, paging channels, and traffic channels, each comprises one or more of multiple time slots in a same frequency bandwidth. However, those who are of ordinary skill in the art realize that communication system 100 may operate in accordance with any wireless telecommunication system, such as but not limited to a General Packet Radio Service (GPRS) communication system, a Code Division Multiple Access (CDMA) 2000 communication system, a Time Division Multiple Access (TDMA) communication system, or an Orthogonal Frequency Division Multiple Access (OFDM) communication system.

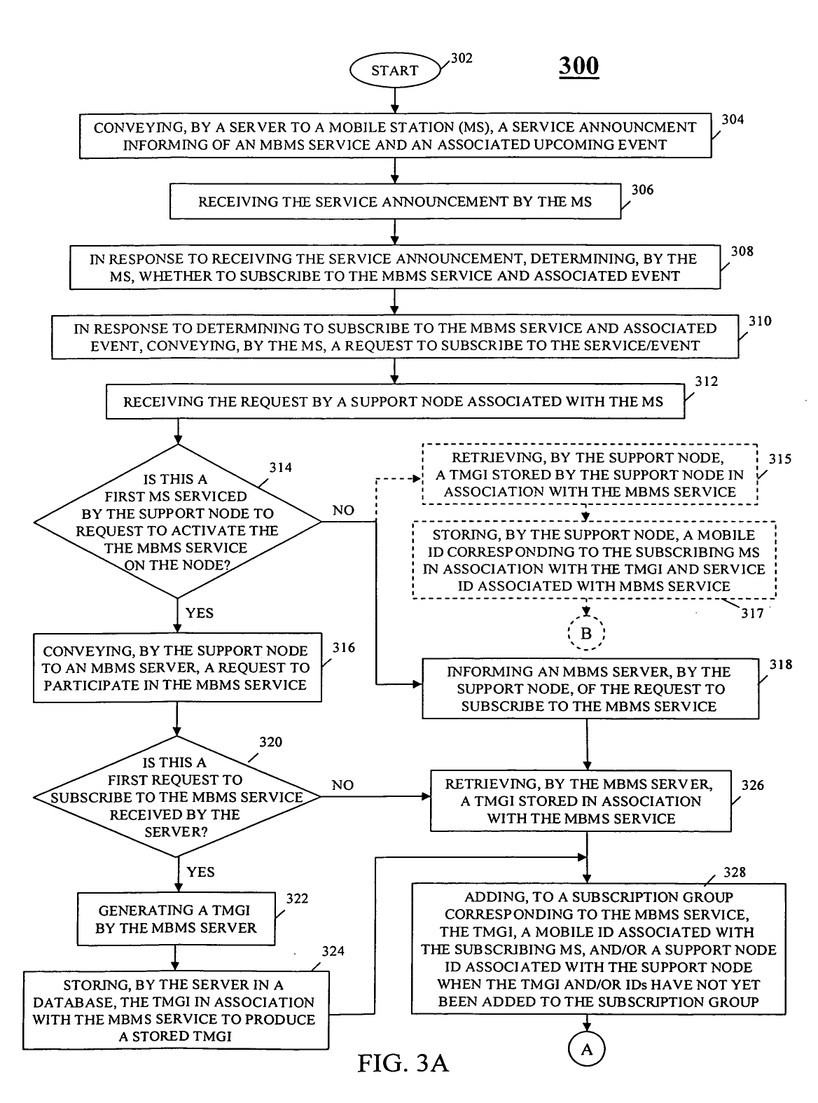

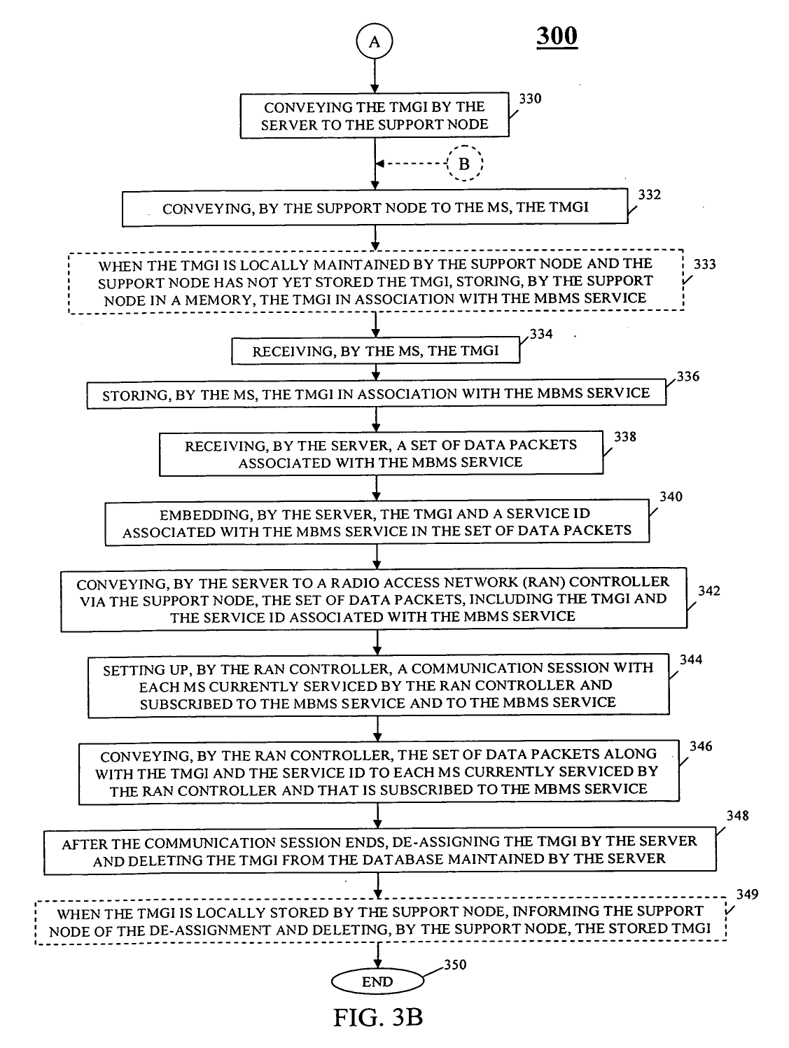

In order for communication system 100 to establish subscription groups related to provision of an MBMS service and to notify subscribed MSs of broadcasts/multicasts of associated MBMS data, communication system 100 generates Temporary Mobile Group Identities (TMGIs) that are each assigned to an MBMS service and distributed to MSs subscribing to the service. FIG. 3 is logic flow diagram 300 of a method by which communication system 100 generates, assigns, and distributes a Temporary Mobile Group Identity (TMGI) associated with an MBMS service in accordance with an embodiment of the present invention. Logic flow diagram 300 begins (302) when communication system 100, and in particular server 122, conveys (304) a service announcement concerning an MBMS service, such as a broadcast of a sporting event such as a Super Bowl game or a World Cup soccer game, to each MS 102-104.

The service announcement may be sent in any over-the-air format, such as via a broadcast over paging channel 131, via a short message service (SMS), or via a multicast. The service announcement comprises information concerning the event, which information may be used by a user of an MS to determine whether to subscribe to the event. For example, the information may include one or more of a Service ID associated with the MBMS service, a routing address, such as an Internet Protocol (IP) address, associated with an MBMS data source, such as MBMS content provider 136, sourcing the data related to the event, a subject category, such as “sports” and/or more specifically “soccer” when the event is a soccer game, concerning the subject matter of the event, an event title, such “World Cup Game No. 1,” and a date and a time of the event.

In response to receiving (306) the service announcement, an MS 102-104, such as MS 102, determines (308) whether to subscribe to the MBMS service identified in the service announcement. When the MS, that is, MS 102, determines to subscribe to the service, the MS conveys (310) to infrastructure 132, and in particular support node 116, a request to subscribe to the MBMS service. The subscription request includes an identifier associated with the MBMS service, preferably the routing address associated with the MBMS service. When MS 102 determines to not subscribe to the service, the MS does not respond to the announcement, other than, perhaps, to acknowledge receipt of the announcement.

In one embodiment of the present invention, an MS 102-104, such as MS 102, may automatically respond to the announcement based on a program stored in the one or more memory devices 208 or based on information programmed into the memory devices by a user of the MS. For example, the MS may be programmed to affirmatively reply to any subscription announcement with a subject category of “sports” or “soccer” and/or subject matter/event title that includes the phrase “World Cup.” In another embodiment of the present invention, at least a portion of the information included in the service announcement may be displayed on display screen 214 of user interface 212, such as “World Cup Game No. 1” along with the date and time of the event. The MS may further display on display screen 214 instructions on how to subscribe, such as text or a softkey that the user may select or a key of a keypad that a user may depress to generate a response. A user of the MS may then subscribe to the event by selecting the indicated text, softkey, or key. In response to a user's selection of the indicated text, softkey, or key, the MS conveys a subscription request to support node 116 indicating a desire of a user of the MS to subscribe to the service, that is, the event. Included in the response is the mobile ID uniquely associated with the MS, allowing support node 116 to determine the source of the response.

In response to receiving (312) the subscription request, support node 116 determines (314) whether the subscribing MS, that is, MS 102, is a first MS to activate this specific MBMS service on this support node. In response to determining that MS 102 is the first MS activating this specific MBMS service on this support node, support node 116 conveys (316) a message to server 122 requesting to participate in the MBMS service. In one embodiment of the present invention, the request may inform of the support node's 116 desire to participate in the MBMS service. In other embodiments of the present invention, the request may inform of the MS's 102 desire to participate in the MBMS service or the support node 116 and the MS's 102 desire to participate in the MBMS service. The message includes an identifier associated with the MBMS service, preferably the Service ID and/or the routing address associated with the service, and a support node identifier that identifies the support node submitting the request, such as a routing address of support node 116. The message may further include a mobile ID associated with subscribing MS 102.

Upon receiving the message to participate in the MBMS service from support node 116, server 122 determines (320) whether this is a first, in time, request received by the server to subscribe to the MBMS service, that is, to join a group associated with the MBMS service or event. When server 122 determines (320) that this is the first request to subscribe to the MBMS service, server 122 generates (322) a Temporary Mobile Group Identifier (TMGI) associated with the service. By locating the TMGI generation and assignment function in server 122 rather than support node 116, communication system 100 provides a centralized repository for all TMGIs and centralized control over the creation, assignment, distribution, and de-assignment of TMGIs, thereby avoiding possible duplicate assignment of TMGIs and maximizing reuse of TMGIs. Server 122 stores (324) the TMGI in a database 128 included in the one or more memory devices 126 of the server to produce a stored TMGI, which TMGI is stored in the database in association with information relating to the MBMS service, such as the Service ID and/or routing address associated with the MBMS service. Server 122 further creates (328) a subscription group associated with the event by storing in the one or more memory devices 126 of the server, preferably in database 128 and in association with the TMGI, the support node identifier, such as a routing address of support node 116, that submitted the request. Server 122 may further store the mobile ID associated with the responding MS, that is, MS 102, when the mobile ID is available to the server.

When server 122 determines (320) that an earlier request to participate the MBMS service has already been received, such that an associated TMGI has already been generated and a subscription group associated with the MBMS service has already been created, the server retrieves (326) the associated TMGI from database 128 and stores (328), in database 128 in association with the TMGI and the corresponding subscription group, the mobile ID associated with the responding MS and a support node identifier (support node ID), such as a routing address of support node 116, associated with the support node servicing the MS.

When support node 116 determines, at step 314, that MS 102 is not the first MS activating this specific MBMS service on this support node, support node 116 conveys (318) a message to server 122 informing of the MS's request to participate in the MBMS service. Logic flow diagram 300 then proceeds to step 326, where server 122, in response to receiving the message informing of the MS's request to participate in the MBMS service, retrieves the associated TMGI from database 128. Server 118 further stores (328) in database 128 in association with the TMGI and the support node identifier associated with the support node servicing the MS, the mobile ID associated with the responding MS.

In response to generating or retrieving the TMGI associated with the MBMS service, server 122 conveys (330, 332) the TMGI to the responding MS 102-104 via the support node, that is, support node 116, servicing the MS. When support node 116 locally maintains the TMGI in the one or more memory devices 120 of the support node and the support node has not yet stored the TMGI, then in response to receiving the TMGI from server 122, support node 116 stores (333) the TMGI, in association with the mobile ID corresponding to MS 102 and the Service ID associated with the MBMS service, in the one or more memory devices 120.

Similar to the service announcement, the TMGI may be conveyed to MS 102 via any cell broadcast format, such as via a paging message over a paging channel, via a short message service (SMS) message, of via a multicast message. In one embodiment of the present invention, server 122 conveys the TMGI to support node 116 and the support node then conveys the TMGI to MS 102 in a modified version of an Activate MBMS Context Accept Message. Activate MBMS Context Accept Messages are known in the art and are described in 3GPP TR 23.846. In communication system 100, the Activate MBMS Context Accept Message is modified to include a TMGI data field in which support node 116 embeds the TMGI received from server 122. In addition, the message conveying the TMGI may further include the mobile ID associated with the MS subscribing to the event, allowing the MS to determine that it is an intended recipient of the TMGI.

In another embodiment of the present invention, support node 116 may locally store a TMGI in the one or more memory devices 120 of the support node. That is, when a first MS, such as MS 102, subscribes to the MBMS service via support node 116, the support node receives a TMGI from server 122 in response to conveying to the server a request to participate in the MBMS service, as is described above. Support node then stores the received TMGI in the one or more memory devices 120 of the support node in association with the Service ID corresponding to the MBMS service and a mobile ID corresponding to the first MS 102. When a second MS, such as MS 103, serviced by support node 116 later conveys to the support node a request to participate in the MBMS service, the support node may merely retrieve (315) the TMGI from the one or more memory devices 120 of the support node and convey (332) the TMGI to the MS, that is, MS 103, without obtaining the TMGI from server 122. In such an embodiment, support node 116 further stores (317) the mobile ID associated with the later subscribing MS, that is, MS 103, in the one or more memory devices 120 in association with the TMGI and the Service ID corresponding to the MBMS service.

When an MS, such as MS 102, receives (334) the TMGI, MS 102 stores (336) the TMGI in a table 210 in the one or more memory devices 208 of the MS. Preferably, the TMGI is stored in table 210 in association with the IP multicast address and the APN associated with the MBMS service. Unless otherwise specified herein, all functions described as being performed herein by an MS 102-104 are performed by the processor 206 of the MS, and all functions described as being performed herein by support node 116 or server 122 are respectively performed by processor 118 of the support node and processor 124 of the server.

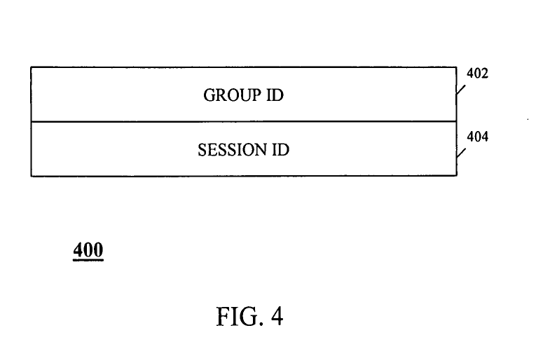

FIG. 4 is a bit layout 400 of a TMGI in accordance with an embodiment of the present invention. In one embodiment of the TMGI, the TMGI comprises a first, Group Identifier (Group ID), data field 402 in which is embedded a Group Identifier (Group ID) associated with the subscription group or MBMS service. In one embodiment of the present invention, the Group ID may be derivative of other information identifying the service, such as the Service ID corresponding to the MBMS service, the routing address associated with MBMS service, or the routing address and the APN associated with MBMS service. The Group ID may comprise such information or, when bit space is limited, comprise a shortened version of such information. For example, server 122 may apply a hashing function to the information in order to determine a shortened version of such information. In another embodiment of the present invention, the Group ID may be any identifier that uniquely identifies the service, such as an event name such as “World Cup Soccer 2004, Game 1” or an event name, date, and time.

In another embodiment of the TMGI, the TMGI may further comprise a second data field 404 in addition to first data field 402. Embedded in the second data field 404 is an identifier associated with each communication session of one or more communication sessions associated an MBMS service. That is, an MBMS service may broadcast an event via multiple communication sessions. For example, an MBMS service may concern a broadcast of a sporting event, such as a soccer game. Rather than provide a continuous broadcast of the event, the MBMS service broadcasts the event via multiple communication sessions, wherein each communication session of the multiple communication sessions concerns a separate aspect of the event, such as a video clip or text concerning each of multiple goals, periodic score updates, and/or periodic game highlights. Each communication session of the multiple communication sessions may then be associated with a unique identifier, such as a Session Identifier (Session ID) or a Sequence Identifier (Sequence ID) that is generated by MBMS content provider 136 or by server 122. For example, a first communication session, such as a first goal, may be associated with a Session or Sequence ID of ‘1,’ a second communication session, such as a second goal, may be associated with a Session or Sequence ID of ‘2,’ and so on. Session IDs are not necessarily sequential, whereas Sequence IDs are sequential. The Session or Sequence ID is then embedded by the network element generating the ID in a data packet associated with the communication session.

By including a Session ID or a Sequence ID in the TMGI, a subscriber to the MBMS service is better able to detect a retransmission of the MBMS data, and hence the subscriber can decide whether to receive the retransmission. For example, before a set of one or more MBMS data packets associated with an MBMS communication session are conveyed by MBMS content provider 136 to RAN controller 114 via server 122, the TMGI, which may include a session ID or a sequence ID, is conveyed to RAN controller 114. RAN Controller 114 then broadcasts the TMGI to the MSs 102-104 subscribed to the service. Upon receiving the TMGI, an MS 102-104 parses the TMGI to obtain the Session ID or Sequence ID and stores the obtained ID. When the MS detects that the Session ID or Sequence ID is already received (from its memory), the MS may reject the reception of the coming MBMS data of this session, or query the user for a decision as to whether to receive the data.

Upon initiation of the event corresponding to the MBMS service, server 122 receives (338), from MBMS content provider 136, a set of data packets comprising payload data associated with the event, such as a score, a highlight, and/or a video clip. In response to receiving the set of data packets, server 122 conveys (342) the set of data packets to RAN controller 114 via support node 116, with the Service ID and the TMGI associated with the MBMS service embedded (340), by the server, in the data packets. Server 122 may further include with the conveyed data packets a ‘Session Description’ associated with the payload included in the data packets. The ‘Session Description’ is a word or a phrase that is descriptive of the payload included in the set of data packets, such as “goal 1,” “goal 2,” and so on. In one embodiment of the present invention, the ‘Session Description’ may be embedded in the set of data packets by server 122. In another embodiment of the present invention, MBMS content provider 136 may embed the ‘Session Description’ in the set of data packets.

In response to receiving the set of data packets and associated Service ID and TMGI, RAN controller 114 sets up (344) a communication session with each MS 102-104 that is currently serviced by the RAN controller and that is subscribed to the MBMS service. RAN controller 114 sets up the communication session in accordance with well-known MBMS communication session set up techniques, except that as part of the process of setting up the communication session the RAN controller additionally conveys to each MS the TMGI assigned to the subscription group and may further convey the Session Description describing the payload.

For example, in one embodiment of the present invention, the step of setting up (344) the communication session may include the following steps. RAN controller 114 broadcasts an MBMS notification, via transceiver 112 and downlink control channel 136, to all MSs serviced by the RAN. The first notification includes the Service ID associated with the MBMS service, the TMGI assigned to the subscription group, and the Session Description associated with the received set of MBMS data. In response to receiving the MBMS notification, each MS that is subscribed to the MBMS service and is in idle mode wakes up. In addition, in response to receiving the MBMS notification, each MS 102-104 subscribed to the MBMS service further checks the one or more memory devices 208 of the MS to determine if the Session Description included in the notification matches a Session Description maintained in the one or more memory devices. When no match is found, each MS in the cell that is subscribed to the MBMS service and that receives the first notification conveys a connection request, typically a Radio Resource Control (RRC) connection establishment request, to RAN controller 114 via an access channel. Upon receiving the connection requests from each of the subscribing MSs, RAN controller 114 sets up a communication session by establishing a PTM communication channel or PTP communication channels with each responding MS, whichever the RAN controller has determined to establish.

Upon establishing the PTM communication channel or PTP communication channels, RAN controller 114 then conveys (346) the set of data packets to the subscribing MSs 102-104 via the established channel or channels. Upon receiving the set of data packets, each MS 102-104 stores, in the one or more memory devices 208 of the MS, the Session Description included in the set of data packets and displays the Session Description and the payload, such as the score or video clip, included in the set of data packets on the display screen 214 of user interface 212. When the event ends, server 122 de-assigns (348) the TMGI to the event, thereby freeing up the TMGI for assignment to another event. In the embodiment of the present invention wherein the TMGI is locally stored by support node 116, the server 122 further informs (349) the support node of the de-assignment of the TMGI and the support node deletes the stored TMGI from the one or more memory devices 120 of the support node. Logic flow diagram 300 then ends (350).

In one embodiment of the present invention, server 122 does not de-assign the TMGI until after an expiration of a first, predetermined period of time after the event. By waiting a predetermined period of time after the end of the event before de-assigning the TMGI, server 122 allows MSs subscribed to the event to obtain replays of MBMS data and re-conveyance of missing MBMS data during the predetermined period of time. For example, when the event is a sporting event, server 122 may not de-assign the TMGI until one or two days after the event has ended. However, the predetermined period of time is up to the designer of communication system 100 and may vary based on the type of event being broadcast, such as a sporting event, concert, speech, and so on. In another embodiment of the present invention, the first period of time may be dynamically determined. For example, server 122 may periodically query support node 116 as to whether any requests for replays or re-conveyances of MBMS data associated with the event have been received from a subscribing MS. When server 122 determines that no requests for replays or re-conveyances of MBMS data have been received during a second period of time, then the server de-assigns the TMGI associated with the event. Server 122 determines the first and second periods of time by reference to a timer 130 included in the server and coupled to processor 124, which timer is used by the server to count down the first and second periods of time.

In order to provide for replays of MBMS data and for re-conveyance of missing MBMS data in a manner that is transparent to a RAN, that does not require inter-layer interaction, and that supports conveyance of missed MBMS data to MSs that join an event subsequent to the establishment of one or more communication sessions, communication system 100 further provides for an automatic re-conveyance of event-related data packets by MBMS content provider 136. By re-conveying the data packets, each MS subscribing to the event is provided with an opportunity to capture missed data packets or to replay the information of earlier received data packets. The re-conveyance may occur at any time after the initial conveyance of the data but preferably is sufficiently distant in time from the initial conveyance to capture most late joiners to the group and to allow for those who have temporarily left a coverage area of communication system 100 to return to the system's coverage area.

By providing an MBMS server 122 that generates and assigns/de-assigns Temporary Mobile Group Identities (TMGIs) to the MBMS services, communication system 100 minimizes a likelihood of duplicate assignment of TMGIs. That is, by centrally locating the TMGI generation and assignment functions in MBMS server 122, communication system 100 avoids possible duplicate assignment of TMGIs and maximizes reuse of TMGIs. MBMS server 122 generates a TMGI in response to receiving a request to participate in an MBMS service. MBMS server 122 assigns the TMGI to the MBMS service and stores the TMGI, in association with information relating to the MBMS service, in a database 128 in the one or more memory devices 126 of the server to produce a stored TMGI. MBMS server 122 further conveys the TMGI to a source of the received request, thereby providing for a distribution of the TMGI to a mobile station subscribing to the MBMS service. In one embodiment of the present invention, when a second mobile station request to subscribe to an MBMS service after a first mobile station has earlier subscribed to the MBMS service and a TMGI was earlier created and stored, MBMS server 122 retrieves the stored TMGI from the one or more memory devices 126 of the server and conveys the stored TMGI to the second mobile station. In another embodiment of the present invention, a support node 116 may locally store, in the one or more memory devices 120 of the support node, a TMGI generated and distributed by the MBMS server. When a second mobile station requests to subscribe to an MBMS service after a first mobile station has earlier subscribed to the MBMS service via the support node, the support node may retrieve the TMGI stored in the one or more memory devices 120 of the support node and convey the locally stored TMGI to the second mobile station.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. Furthermore, unless otherwise indicated herein, the use of relational terms, if any, such as first and second, top and bottom, and the like are used solely to distinguish one entity or action from another entity or action without necessarily requiring or implying any actual such relationship or order between such entities or actions.

1. A method for assigning a Temporary Mobile Group Identity (TMGI) to a Multimedia Broadcast/Multicast Service (MBMS) communication session, the method comprising:
receiving, by an MBMS server, a request to participate in an MBMS service;
in response to receiving the request, generating, by the MBMS server, a TMGI;
assigning, by the MBMS server, the TMGI to the MBMS service;
storing, by the MBMS server, the TMGI in association with information relating to the MBMS service to produce a stored TMGI; and
conveying, by the MBMS server, the TMGI to a source of the received request.

2. The method of claim 1, wherein assigning comprises uniquely assigning, by the MBMS server, the TMGI to the MBMS service.

3. The method of claim 1, wherein the Temporary Mobile Group Identity comprises an identifier that uniquely identifies the MBMS service within a wireless communication system.

4. The method of claim 1, further comprising:
receiving, by a support node, a request from a mobile station to subscribe to the Multimedia Broadcast/Multicast Service (MBMS) service; and
in response to receiving the request from the mobile station, conveying, by the support node to the MBMS server, the request to participate in the MBMS service.

5. The method of claim 4, wherein conveying, by the support node to the Multimedia Broadcast/Multicast Service (MBMS) server, the request to participate in the MBMS service comprises:
determining, by the support node, whether the mobile station is a first mobile station to request to activate the MBMS service on the support node; and
when the mobile station is a first mobile station to request to activate the MBMS service on the support node, conveying, by the support node to the MBMS server, the request to participate in the MBMS service.

6. The method of claim 4, wherein conveying, by the support node to the Multimedia Broadcast/Multicast Service (MBMS) server, the request to participate in the MBMS service comprises:
determining, by the support node, whether the mobile station is a first mobile station to request to activate the MBMS service on the support node; and
when the mobile station is not a first mobile station to request to activate the MBMS service on the support node, informing the MBMS server, by the support node, of request to subscribe to the MBMS service.

7. The method of claim 4, wherein storing the Temporary Mobile Group Identity (TMGI) comprises creating, by the Multimedia Broadcast/Multicast Service (MBMS) server, a subscription group by storing the TMGI in association with at least one of a mobile identifier associated with the mobile station and a support node identifier associated with the support node.

8. The method of claim 4, wherein generating a Temporary Mobile Group Identity (TMGI) comprises, when the request to participate in the in the MBMS service received by the MBMS server is a first request to participate in the in the MBMS service received by the MBMS server, generating, by the MBMS server, a TMGI.

9. The method of claim 8, wherein the mobile station comprises a first mobile station, wherein the request to participate in the in the Multimedia Broadcast/Multicast Service (MBMS) service received by the MBMS server is a first request to participate in the in the MBMS service received by the MBMS server, and wherein the method further comprises:
receiving, by the MBMS server, a second request to participate in the MBMS service, wherein the second request is associated with a second mobile station and is received subsequent to the first request;
in response to receiving the second request, retrieving the stored Temporary Mobile Group Identity (TMGI); and
conveying the retrieved TMGI to a source of the received second request.

10. The method of claim 9, wherein storing the Temporary Mobile Group Identity (TMGI) comprises creating, by the Multimedia Broadcast/Multicast Service (MBMS) server, a subscription group by storing the TMGI in association with at least one of a mobile identifier associated with the first mobile station and a support node identifier associated with the support node and wherein the method further comprises adding a mobile identifier associated with the second mobile station to the subscription group.

11. The method of claim 4, further comprising:
receiving, by the support node, the Temporary Mobile Group Identity (TMGI) conveyed by the Multimedia Broadcast/Multicast Service (MBMS) server;
storing, by the support node, the TMGI in association with a mobile identifier associated with the mobile station.

12. The method of claim 4, wherein the mobile station comprises a first mobile station, wherein the request received by the support node from the first mobile station to subscribe to the Multimedia Broadcast/Multicast Service (MBMS) service comprises a first request, and wherein the method further comprises:
receiving, by the support node, a second request from a second mobile station to subscribe to the MBMS service;
in response to receiving the request from the mobile station, retrieving, by the support node, the Temporary Mobile Group Identity (TMGI) stored by the support node; and
conveying, by the support node to the second mobile station, the TMGI retrieved by the support node.

13. The method of claim 1, further comprising:
receiving, by a mobile station, the Temporary Mobile Group Identity (TMGI) conveyed by the Multimedia Broadcast/Multicast Service (MBMS) server; and storing, by the mobile station, the received TMGI.

14. The method of claim 13, further comprising:
receiving, by the Multimedia Broadcast/Multicast Service (MBMS) server, data packets comprising MBMS data associated with the MBMS service;
embedding, by the MBMS server, the Temporary Mobile Group Identity (TMGI) in the data packets;
conveying to the mobile station the data packets with the TMGI embedded therein.

15. The method of claim 14, wherein conveying to the mobile station the data packets with the Temporary Mobile Group Identity (TMGI) embedded therein comprises setting up a communication session and, as part of the communication session, conveying to the mobile station the data packets with the TMGI embedded therein, and wherein the method further comprises:
after the communication session ends, de-assigning, by the MBMS server, the TMGI from the MBMS service; and
deleting, by the MBMS server, the stored TMGI.

16. The method of claim 15, further comprising:
receiving, by a support node, a request from a mobile station to subscribe to the Multimedia Broadcast/Multicast Service (MBMS) service;
in response to receiving the request from the mobile station, conveying, by the support node to the MBMS server, the request to participate in the MBMS service;
receiving, by the support node, the Temporary Mobile Group Identity (TMGI) conveyed by the MBMS server;
storing, by the support node, the TMGI in association with a mobile identifier associated with the mobile station; and
after the communication session ends, deleting, by the support node, the TMGI stored by the support node.

17. A Multimedia Broadcast/Multicast Service (MBMS) server comprising:
at least one memory device;
a processor operably coupled to the at least one memory device that receives a request to participate in an MBMS service, generates a Temporary Mobile Group Identity (TMGI) in response to receiving the request, assigns the TMGI to the MBMS service, stores in the at least one memory device the TMGI in association with information relating to the MBMS service to produce a stored TMGI, and conveys the TMGI to a source of the received request.

18. The Multimedia Broadcast/Multicast Service (MBMS) server of claim 17, wherein the processor uniquely assigns the TMGI to the MBMS service.

19. The Multimedia Broadcast/Multicast Service (MBMS) server of claim 17, wherein the Temporary Mobile Group Identity comprises an identifier that uniquely identifies the MBMS service within a wireless communication system.

20. The Multimedia Broadcast/Multicast Service (MBMS) server of claim 17, wherein the processor stores the Temporary Mobile Group Identity (TMGI) by creating a subscription group by storing the TMGI in association with at least one of a mobile identifier associated with the mobile station and a support node identifier associated with the support node.

21. The Multimedia Broadcast/Multicast Service (MBMS) server of claim 17, wherein the processor generates a Temporary Mobile Group Identity (TMGI) by generating a TMGI when the request to participate in the in the MBMS service received by the MBMS server is a first request to participate in the in the MBMS service received by the MBMS server.

22. The Multimedia Broadcast/Multicast Service (MBMS) server of claim 21, wherein the mobile station comprises a first mobile station, wherein the request to participate in the in the Multimedia Broadcast/Multicast Service (MBMS) service received by the MBMS server is a first request to participate in the in the MBMS service received by the MBMS server, and wherein the processor further receives a second request to participate in the MBMS service, wherein the second request is associated with a second mobile station and is received subsequent to the first request, retrieves the stored Temporary Mobile Group Identity (TMGI) in response to receiving the second request, and conveys the retrieved TMGI to a source of the received second request.

23. The Multimedia Broadcast/Multicast Service (MBMS) server of claim 22, wherein the processor stores the Temporary Mobile Group Identity (TMGI) by creating a subscription group by storing the TMGI in association with at least one of a mobile identifier associated with the first mobile station and a support node identifier associated with a support node servicing the-first mobile station and wherein the processor further adds a mobile identifier associated with the second mobile station to the subscription group.

24. The Multimedia Broadcast/Multicast Service (MBMS) server of claim 17, wherein the processor further receives data packets comprising MBMS data associated with the MBMS service, embeds the Temporary Mobile Group Identity (TMGI) in the data packets, and conveys to a mobile station the data packets with the TMGI embedded therein.

25. The Multimedia Broadcast/Multicast Service (MBMS) server of claim 24, wherein the processor conveys to the mobile station the data packets with the Temporary Mobile Group Identity (TMGI) embedded therein as part of a communication session and wherein the processor further, after the communication session ends, de-assigns the TMGI from the MBMS service and deletes the stored TMGI from the at least one memory device.
